(19) United States
(12) Patent Application Publication
(10) Pub. No.: US 2025/0020563 A1
(43) Pub. Date: Jan. 16, 2025

(54) METHOD FOR DETECTING A FOREIGN BODY IN A MEDIUM

(71) Applicant: Endress+Hauser Flowtec AG, Reinach (CH)

(72) Inventors: Stefan Pflüger, München (DE); Hao Zhu, Freising (DE); Wolfgang Drahm, Freising (DE)

(21) Appl. No.: 18/714,644

(22) PCT Filed: Nov. 28, 2022
(86) PCT No.: PCT/EP2022/083505

§ 371 Date: May 30, 2024

(30) Foreign Application Priority Data
Dec. 3, 2021 (DE) 10 2021 131 866.1

(51) Int. Cl. G01N 9/32; G01F 1/84

(52) U.S. Cl. CPC G01N 9/32; G01F 1/84

(57) ABSTRACT

A method for detecting a foreign body in a flowable medium includes determining a first time curve of a first measured value using a first measuring device for determining a physical density of the medium. The method also includes determining a second time curve of a second measured value using a second measuring device for ascertaining a relative permittivity of the medium. A temporal correlation between the first curve and the second curve is determined, and pairs of measured values of the first measured value and the second measured value are detected. The method further includes checking whether the detected pairs of measured values within a predefined tolerance interval correspond to the correlation of at least one predefined function. If this is not the case, it is established that the foreign body is present in the medium.

The invention relates to a method for detecting a foreign body in a flowable medium, in particular with a variable gas charge and preferably with free bubbles.

It is possible, in particular by means of microwaves, to determine the physical quantities of permittivity and loss factor of a medium in a process pipe. From these two variables-measured either at one or over many different frequencies—it is possible to draw conclusions regarding application-specific parameters, for example the proportion of water in a mixture of water and other non-polar or weakly polar components.

The established transmission/reflection measurement is described in L. F. Chen, C. K. Ong, C. P. Neo, V. V. Varadan, V. K. Varadan—“Microwave Electronics, Measurement and Materials Characterization,” John Wiley & Sons Ltd., 2004. For this purpose, the microwave signal interfaces at two different positions at the medium in a container or measuring pipe, the scatter parameters (transmission and optionally reflection) are measured between these interface structures, and the mentioned physical properties of the medium are calculated from the measured scatter parameters.

WO 2018 121927 A1 teaches a measuring assembly for analyzing properties of a flowing medium by means of microwaves. In addition to the microwave antennas, the measuring assembly has an electrically insulating lining layer on the inner peripheral surface of the measuring pipe. This lining layer forms a dielectric waveguide via which at least part of the microwaves can travel from a first microwave antenna to a second microwave antenna. One application for such a measuring assembly is the determination of the proportions of solids in the medium being conveyed.

In process, measurement and automation technology, measuring devices are often used to measure physical parameters of a fluid flowing in a pipeline, such as the mass flow rate, density and/or viscosity, which, by means of a vibration-type sensor inserted in the course of the fluid-carrying pipeline, through which the fluid flows during operation, and a measuring and operating circuit connected to it, bring about reaction forces in the fluid, such as Coriolis forces corresponding to the mass flow rate, inertial forces corresponding to the density, or frictional forces corresponding to the viscosity, etc., and, derived from these, generate a measurement signal representing the respective mass flow rate, the respective viscosity, and/or the respective density of the fluid. Such vibration-type sensing elements are described, for example, in WO 03/076880 A1, WO 02/37063 A1, WO 01/33174 A1, WO 00/57141 A1, WO 99/39164 A1, WO 98/07009 A1, WO 95/16897 A1, WO 88/03261 A1, US 2003/0208325, US 65 13 393 B1, US 65 05 519 B1, US 60 06 609 A1, US 58 69 770 A1, US 57 96 011 A1, US 56 02 346 A1, US 53 01 557 A1, US 52 18 873 A1, US 50 69 074 A1, US 48 76 898 A1, US 47 33 569 A1, US 46 60 421 A1, US 45 24 610 A1, US 44 91 025 A1, US 41 87 721 A1, EP 553 939 A1, EP 1 001 254 A1 or EP 1 281 938 A1.

According to Article 5 of Regulation No. 852/2004 of the European Community (EC), food processing companies are obliged to comply with the HACCP principles. HACCP stands for “Hazard Analysis Critical Control Points.” HACCP requires a hazard analysis and review of all critical points of any process step in the preparation, processing, production, packaging, storage, transportation, allocation, handling and distribution of food. The aim of HACCP is to guarantee safe food. To achieve this, foreign bodies must be prevented from entering the food. Foreign bodies are usually understood to be stones, glass, metallic or ceramic particles, agglomerates of the medium to be conveyed, plastics particles, or fruit stones. Foreign bodies in the present invention can also be understood as gas bubbles that are undesired in the medium to be conveyed.

DE102016120303A1 discloses a magnetic-inductive flowmeter which has a foreign body electrode in addition to the conventional measuring electrode pair. The foreign body electrode is designed to detect foreign bodies in the medium by interpreting a deviation of the determined electrical potential from a modulation as being caused by a foreign body. DE102016116072A1 discloses a measuring arrangement comprising a magnetic-inductive flowmeter and an ultrasonic flowmeter in place of the foreign body electrode. A deviation of the determined measurement signal of the ultrasonic flowmeter from the modulation is interpreted as being caused by a foreign body.

DE102016116070A1 discloses a measuring arrangement comprising a vortex flowmeter and an ultrasonic flowmeter arranged on the downstream side of the baffle. The detection of foreign bodies makes use of the fact that the ultrasonic signal is reflected by the foreign bodies. The measuring signal of the ultrasonic flowmeter is compared with the modulation caused by the vortex street and in the event of a deviation this is interpreted as being caused by the foreign body.

A disadvantage of the aforementioned prior art is that no solution yet exists for distinguishing foreign bodies and/or identifying foreign bodies in a gas-laden or gas bubble-laden medium.

The object of the invention is to remedy this.

The object is achieved by the method according to claim 1 and the measuring arrangement according to claim 17.

The method according to the invention for detecting a foreign body in a flowable medium, in particular with a variable gas charge and preferably with free bubbles, comprising the method steps of:
determining a first time curve of a first measured value by means of a first measuring device, in particular a Coriolis flowmeter, for determining a physical density of the medium,
   wherein the first measured value correlates with the physical density and/or the change in the physical density of the medium over time;
determining a second time curve of a second measured value by means of a second measuring device, in particular a microwave sensor, for ascertaining a relative permittivity of the medium,
   wherein the second measured value correlates with the relative permittivity and/or a change in the relative permittivity of the medium over time,
determining a temporal correlation between the first curve and the second curve;
detecting pairs of measured values of the first measured value and the second measured value;
checking whether the detected pairs of measured values within a predefined tolerance interval correspond to the correlation of at least one predefined function; and
if this is not the case, establishing that the foreign body is present in the medium.

The measuring assembly according to the invention comprises:
a pipeline for conveying a medium in a flow direction;
a Coriolis flowmeter,
a microwave sensor,
   wherein the microwave sensor and the Coriolis flowmeter are integrated in the pipeline and offset relative to one another in the flow direction;
an evaluation circuit which is designed to carry out the method according to the invention.

A time curve comprises at least one measured value, but usually at least two measured values determined in succession. The determined time curves are correlated with each other over time so that an event that occurs—e.g., a foreign object passes the first measuring device at a first point in time and the second measuring device at a second point in time—is assigned to a common point in time.

The function can have a linear relationship with a gradient and optionally an offset. If the pairs of measured values lie on the predefined function—in this case on the straight line—or within the tolerance range, they correspond to the predefined function.

Multiple functions can also be stored, each for different types of foreign bodies, which differ in terms of different gradients or which are described by different shapes or mathematical functions. Alternatively, two functions that limit a tolerance range can also be stored.

The evaluation circuit has at least one microprocessor, which is designed to take over at least the method step of checking, for detecting the foreign bodies. For this purpose, the evaluation circuit can have a data memory in which the information relating to the at least one function is stored. The evaluation circuit can be arranged in one of the two measuring devices or in a process control system. Alternatively, the evaluation circuit can also be in communication with a cloud in which the measured values are stored. This means that the evaluation circuit does not necessarily have to be arranged locally on the measuring arrangement.

Advantageous embodiment of the invention are the subject matter of the dependent claims.

One embodiment provides that at least one pair of measured values of the first measured value and the second measured value for a medium free of foreign bodies and bubbles, and/or pairs of measured values of the first measured value and the second measured value for a medium free of foreign bodies with an in particular variable gas charge, in particular in the form of free bubbles, can be represented by the at least one predefined function.

The predefined function is known and is available to the evaluation circuit or is stored in the evaluation circuit. The function that describes a medium free of foreign bodies and bubbles can be described by a single pair of measured values-namely the density measured value and the permittivity measured value of the flowing medium, or the zero point when considering the changes in the density and permittivity of the medium over time. Alternatively, the function can also include all pairs of measured values that lie within a shape that at least partially encloses the above pair of measured values—e.g., a circle or a rectangle. The function that describes a foreign body-free medium with a variable gas charge, in particular in the form of free bubbles, is, for example, a straight line that runs through the pair of measured values obtained in the case of a foreign body-free and bubble-free medium.

One embodiment provides that pairs of measured values of the first measured value and the second measured value for a reference condition can be represented by the at least one predefined function.

The reference condition can originate from a plurality of reference conditions. The reference conditions are previously defined cases in which the medium is in each case mixed with foreign bodies that have different physical properties, in particular different densities and/or permittivities. The reference conditions can be previously computer-simulated or experimentally set, and the predefined function can be determined from the reference measured values thus obtained. The function describing the reference condition can be a straight line that has a gradient that differs from the gradient of the function describing the foreign body-free medium with a variable gas charge.

One embodiment provides that the reference condition is the passage of a plastics foreign body, in particular a plastics foreign body of a first type and/or a plastics foreign body of a second type, and/or a foreign body comprising silicon dioxide,
wherein the plastics foreign body of the first type has a density of less than 1000 kg/m³,
wherein the plastics foreign body of the second type has a density greater than or equal to 1000 kg/m³.

In one embodiment, a check is made as to whether the detected pairs of measured values correspond to the context of a plurality of predefined functions within the respective predefined tolerance range.

Accordingly, the predefined function can also be the corresponding, in particular also a selected, function from multiple functions, each of which corresponds to one of multiple defined reference conditions.

One embodiment provides that the checking comprises the creation of a monitoring value depending on the pair of measured values, or the first measured value and the second measured value, and the comparison of the monitoring value with a monitoring criterion.

The monitoring value can, for example, be the gradient of a straight line that runs through the determined pairs of measured values, or the time derivative of the time curve of the pairs of measured values. Alternatively, the monitoring value can also be an angle of a measurement vector, which always points to the currently determined pair of measured values.

One embodiment provides for a ratio of the first measured value, in particular the change in physical density over time, and the second measured value, in particular the change in relative permittivity over time, to be included in the generation of the monitoring value.

In one embodiment, the first measured value, in particular the change in physical density over time, is plotted against the second measured value, in particular the change in relative permittivity over time.

One embodiment provides for the monitoring value to have an angle between a measurement vector pointing to the pair of measured values and a reference axis,
wherein the monitoring criterion comprises an angular range.

In this case, the reference axis can correspond to the X-axis (change in permittivity), the Y-axis (change in density), or an axis that runs along the function for describing the foreign body-free medium with a variable gas charge.

One embodiment provides that the measurement vector has a measurement vector length,
wherein the measurement vector length is included in the determination of the size of the foreign body.

The size can be an effective diameter or an effective cross-sectional area. If the type of foreign body is known, an effective mass of the foreign body can also be determined on the basis of the determined density or density change.

One embodiment provides that the measurement vector has a measurement vector length,
wherein a further monitoring criterion comprises a minimum length for the measurement vector length,
wherein this is only interpreted as being caused by a foreign body if the minimum length is exceeded.

In one embodiment, the monitoring value corresponds to a gradient of a reference straight line that runs through the pair of measured values,
wherein the monitoring criterion defines a gradient range.

In this case, the gradient range can be spanned by two further functions and thus describe an area or a set of pairs of measured values. The two other functions can also serve as boundaries between different reference conditions.

One embodiment comprises the method steps of:
creating a monitoring value depending on the measured value pairs,
   wherein the first measured value is entered with a first weighting,
   wherein the second measured value is entered with a second weighting;
comparing the monitoring value with a monitoring criterion,
   wherein the monitoring criterion comprises an in particular variable monitoring limit value,
   wherein the first weighting and the second weighting are selected such that the monitoring value is below the monitoring limit value when a foreign body-free, but in particular gas-charged, medium passes.

The advantage of this embodiment is that it enables the detection of foreign bodies in a gas-charged medium. The weightings can be variable.

One embodiment provides for the first curve and the second curve to be correlated taking into account a flow measured value determined in particular by means of the Coriolis flowmeter in combination with a distance between the Coriolis flowmeter and the second measuring device, in particular the microwave sensor.

In applications where the medium has a variable flow rate, it is not sufficient to synchronize the two measuring devices once—e.g., at the factory. It is advantageous if the measuring device for determining the density is a Coriolis flowmeter, as this can also be used to determine a flow rate of the medium. In this way, the temporal correlation of the two time curves can take place continuously.

In one embodiment, the first curve and the second curve are correlated taking into account a time offset determined on the basis of a cross-correlation of the first curve and the second curve.

One embodiment provides that the monitoring criterion is a variable criterion that is determined by means of an in particular self-learning AI algorithm, in particular based on neural networks.

The invention is explained in greater detail with reference to the following figures. In the figures:

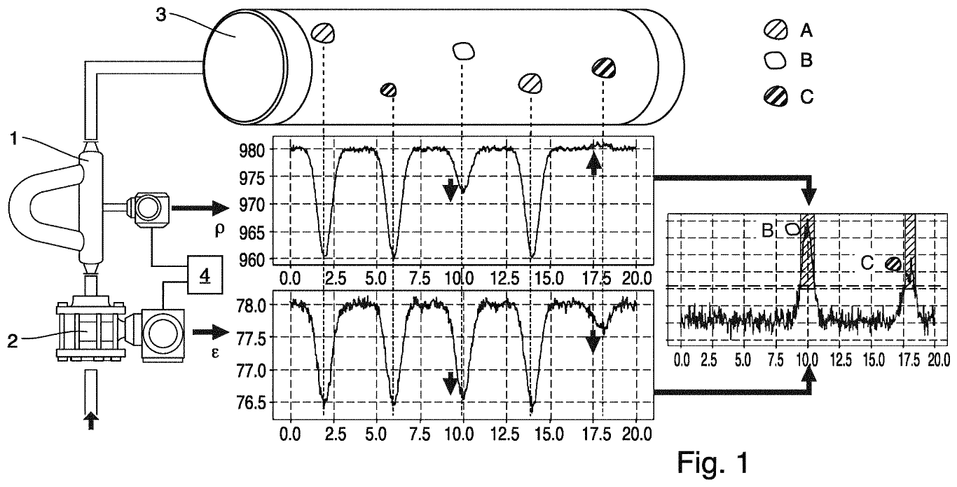

FIG. 1: shows a schematic view of a measuring arrangement in conjunction with two time-correlated time curves of the respective measured values and a time curve of the monitoring values resulting from the curves;

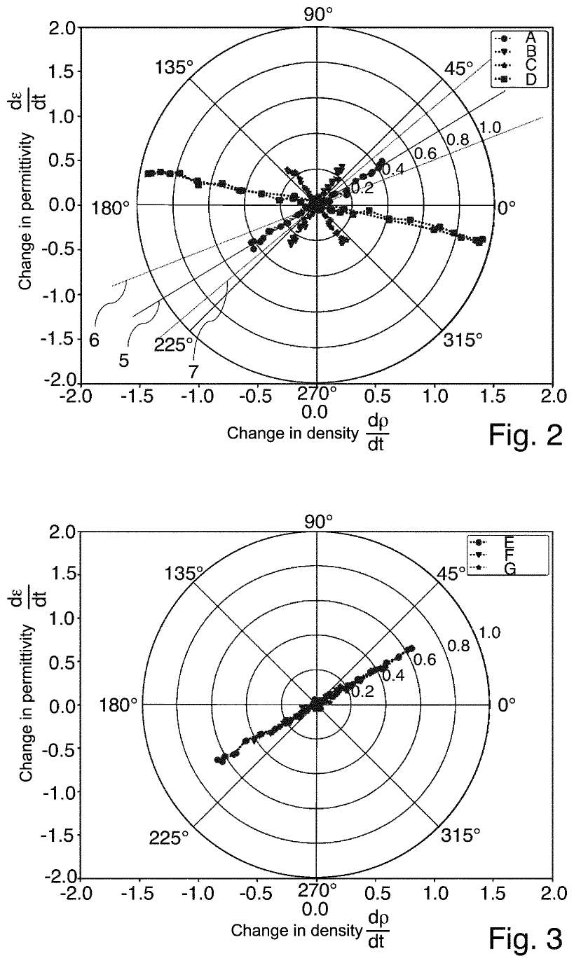

FIG. 2: shows a function of the normalized change in permittivity over time as a function of the normalized change in density over time for different reference conditions A to D;

FIG. 3: shows a function of the normalized change in permittivity over time as a function of the normalized change in density over time for air bubbles of different bubble sizes; and

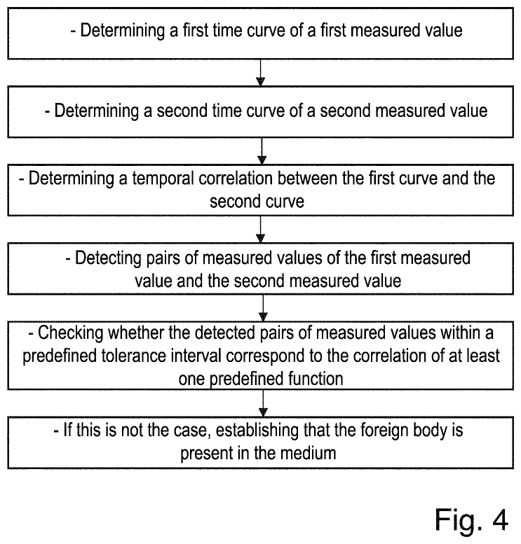

FIG. 4: shows a flow diagram of an embodiment of the method according to the invention.

FIG. 1 shows a schematic view of a measuring arrangement in conjunction with two time curves of the measured values (=measuring signal) and a time curve of the monitoring values (=monitoring signal) resulting from the two curves. The measuring arrangement comprises a pipeline 3 for guiding a medium in a flow direction, a first measuring device in the form of a Coriolis flowmeter 1, a second measuring device in the form of a microwave sensor 2, and an evaluation circuit 4 which is designed and configured to carry out the method according to the invention (see, for example, FIG. 4). In this case, the microwave sensor 2 and the Coriolis flowmeter 1 are integrated in the pipeline 3 and arranged offset relative to one another in series in the flow direction. That is to say that the medium first passes one of the two measuring devices and then—with a time offset—the other measuring device. The measuring signal of the Coriolis flowmeter is the density of the medium as a function of time. The measuring signal of the microwave sensor is the relative permittivity of the medium as a function of time. Alternatively, the measuring signals can each comprise the change over time (derivative) of the aforementioned measured variables or measurement signals of other measured variables that depend on the density or permittivity or the change in density or permittivity.

Due to the spatially separated arrangement of the two measuring devices, there is a time delay between the passage of the foreign body through the first and second measuring device. This must be compensated for by aligning the time curves of the measured values of the two measuring devices before further signal processing, in particular before detecting pairs of measured values. This alignment can be achieved, for example, by:
calculating the current time offset between the two measuring devices based on the measured flow rate of the medium and the known installation position, in particular the known distance between the two measuring devices, or
calculating, section-by-section, the cross-correlation of the two time curves of the measured values, and determining the time offset on the basis of the maximum of the cross-correlation function.

A flowable medium in which various foreign bodies-marked A, B and C—are present flows through pipeline 3. In the example shown, foreign body A is an air bubble. For air bubbles, the very low density (ρ≈2 kg/m³) and permittivity (εᵣ≈1) of air results in a significant decrease in the measured values of both measuring devices over time.

Foreign body B is a plastics foreign body according to type 2, i.e., a foreign body made of a plastics having a lower density than water (ρ≈800 kg/cm³). In the present case, the foreign body B has a relative permittivity of εᵣ≈3. Compared to the air bubbles, although a plastics foreign body causes a comparable reaction in the measuring signal of the microwave sensor, the fluctuation in the measuring signal of the Coriolis flowmeter is much smaller in comparison.

Foreign body C is an agglomerate of the medium to be conveyed. The agglomerate can be, for example, pasta that has not been completely broken up in baby food, or unwanted pieces of strawberry in strawberry yogurt. The measuring signal of the Coriolis flowmeter shows only an insignificant increase in the density value. This is due to the smaller amount of water in the agglomerate. The measuring signal of the microwave sensor decreases only slightly compared to the behavior with foreign bodies B and C, but still noticeably.

In this example, foreign bodies are intended to be detected in the gas-charged medium. In this case, gas bubbles are not treated as foreign bodies. A simple way of detecting foreign bodies is to combine the individual measurement signals linearly with variable weightings to create a monitoring signal. In this case, the weightings can be selected so that the monitoring signal for a specific type of foreign body (in the example in FIG. 1: air bubbles) as a result of the linear combination is essentially zero. While a detectable event remains in the monitoring signal for all physically different foreign bodies, the signals caused by air bubbles are masked out in this way, in the result. As can be seen in the monitoring signal, all events caused by air bubbles are below the monitoring limit value. As the foreign body B causes a significant change, i.e., a decrease in the measurement signal strength, in both measurement signals, the passage of precisely this foreign body is noticeable in the monitoring signal. The foreign body C can also be detected in the monitoring signal by selecting suitable weightings. This achieves the goal of robust foreign body detection compared with air bubbles.

Further analyses with a different selection of weightings can also be used to yet further classify the remaining detected events based on the physical properties of the particles. The previous step provides a numerically quantified statement about the deviation from the normal state. In the simplest case, a monitoring criterion in the form of a monitoring limit value can now be defined for the signaling of a detection event, the exceeding of which triggers an alarm. In addition, it is also possible to use statistical algorithms that adaptively adjust the monitoring limit value based on past measurements (example: see CFAR algorithm, constant false alert rate).

Another possibility is to use machine learning methods that are trained in advance to separate the normal state of a flow with air bubbles contained therein from the passage of a foreign body. The training can also take place continuously online, on the basis of previous measurements, in order to continuously adapt the recognition of the normal state to the current process.

FIG. 2 shows a function of the normalized change in permittivity over time as a function of the normalized change in density over time for different reference conditions A to D. The following reference conditions are shown. In all reference conditions, the medium is water. The circular symbols represent the pairs of measured values that are formed when an air bubble passes through the two measuring devices. The triangular symbols represent the pairs of measured values resulting from the presence of a PTFE (polytetrafluoroethylene) foreign body-which belongs to the category of plastics materials of the first type. The star-shaped symbols stand for pairs of measured values that can be obtained if the medium is contaminated by a POM (polyoxymethylene) foreign body (plastics material of the second type). The square symbols represent pairs of measured values that are obtained when a glass body flows past the measuring devices. If there is no foreign body in the medium, then a constant density over time and a constant permittivity over time are expected, i.e., the pairs of measured values in this case lie at the intersection of the X-axis (change in density) and the Y-axis (change in permittivity), or fluctuate around the intersection point depending on the measuring accuracy of the corresponding measuring devices. An examination of the functions shown in FIG. 2 enables a clear distinction to be made between the individual foreign bodies. The course of all pairs of measured values of the reference conditions shown can be described by a straight line 5, or the pairs of measured values lie within a straight line 6, 7 spanning the tolerance range. The straight lines have different gradients for the respective reference conditions. In the case of an unweighted plot of the change in permittivity against the change in density, a straight line with a gradient of 0.0807 m³/kg or a measurement vector with an angle of +4.61° is obtained for air bubbles. In this case, the angle between the measurement vector and the X-axis is spanned. The behavior of the measured value when a PTFE foreign body passes can be described by a straight line with a gradient of 0.1986 m³/kg or a measuring vector with an angle of +11.23°. The measured values look quite different when POM foreign bodies pass. This can be described by a straight line with a gradient of −0.1863 m³/kg or a measurement vector with an angle of +10.55°. The gradient is negative in this case. The gradient of the straight line describing the presence of a glass body is also negative. Similar behavior is also expected in the presence of a rock body. In this case, the straight line has a gradient of −0.0274 m³/kg or the measurement vector has an angle of +1.57°. Depending on the normalization of the respective axes, the gradient or angle may deviate from the listed values by a normalization-dependent factor. In the present example, the change in density forms the X-axis, and the change in permittivity forms the Y-axis. Alternatively, the X-axis and the Y-axis can be swapped. In this case, the gradient of the specified functions is the reciprocal of the above-mentioned gradients or the reciprocal with a normalization-dependent prefactor. The tolerance range can be spanned by two straight lines, each of which results from the gradient of the predefined functions in conjunction with a percentage.

FIG. 3 shows a curve of the normalized change in permittivity over time as a function of the normalized change in density over time for air bubbles of different bubble sizes. The bubble size of the bubbles in reference condition E is 3 cm, the bubble size of the bubbles in reference condition F is 2 cm, and the bubble size of the bubbles in reference condition G is 3 cm. It can be seen that the maximum deflection of the measured value curve or the maximum length of the measurement vector of the measurement data pairs depends on the size of the air bubbles, but the gradient of the straight line-on which the measurement value pairs lie-does not.

FIG. 4 shows a flow diagram of a first embodiment of the method according to the invention having the method steps of:
determining a first time curve of a first measured value, which correlates with the physical density and/or the change in the physical density of the medium over time, and is measured by means of a first measuring device for determining a physical density of the medium, in particular by means of a Coriolis flowmeter.
determining a second time curve of a second measured value, which correlates with the relative permittivity and/or a change in the relative permittivity of the medium over time, and is measured by means of a second measuring device for determining a relative permittivity of the medium, in particular by means of a microwave sensor.
determining a temporal correlation between the first curve and the second curve. This method step can be carried out continuously or when setting up the measuring arrangement.
detecting pairs of measured values of the first measured value and the second measured value.
checking whether the detected pairs of measured values within a predefined tolerance interval correspond to the correlation of at least one predefined function. Alternatively, it can be checked whether the detected pairs of measured value correspond to the context of a plurality of specified functions, within the respective predefined tolerance range. For example, in a first step it is possible to check whether the detected pair of measured values lies within a range that is characteristic for pairs of measured values that usually occur when a medium free of foreign bodies passes. This range depends on the noise caused by the measuring device and the measuring stability of the respective measuring devices. Alternatively, a monitoring value can be created from each detected pair of measured values, which monitoring value is compared with a monitoring criterion. A ratio of the first measured value, in particular the change in physical density over time, and the second measured value, in particular the change in relative permittivity over time, is included in the creation of the monitoring value. Furthermore, the first measured value, in particular the change in physical density over time, is plotted against the second measured value, in particular the change in relative permittivity over time. The monitoring value can be a gradient or an angle of a measurement vector that points to the pair of measured values. In this case, the angle through the measurement vector and a reference axis is spanned. The reference axis can be the X or Y-axis, or an axis that runs through the predefined function of a gas bubble-charged medium.
if this is not the case, establishing that the foreign body is present in the medium.

In a further method step, the size of the foreign body can be determined. This can be used to trigger the opening of a valve or the issuing of a warning.

A second embodiment of the method according to the invention has the following method steps:
determining a first time curve of a first measured value, which correlates with the physical density and/or the change in the physical density of the medium over time, and is measured by means of a first measuring device for determining a physical density of the medium, in particular by means of a Coriolis flowmeter.
determining a second time curve of a second measured value, which correlates with the relative permittivity and/or a change in the relative permittivity of the medium over time, and is measured by means of a second measuring device for determining a relative permittivity of the medium, in particular by means of a microwave sensor.
determining a temporal correlation between the first curve and the second curve.
detecting pairs of measured values of the first measured value and the second measured value.
creating a monitoring value depending on the measured value pairs. In this case, the first measured value is included in the monitoring value with a first weighting and the second measured value with a second weighting.

According to the second embodiment, the method step of checking whether the detected pairs of measured values, within a predefined tolerance range, correspond to the context of at least one predefined function, is replaced by comparing the monitoring value with a monitoring criterion. The monitoring criterion comprises an in particular variable monitoring limit value, and the first weighting and the second weighting are selected such that the monitoring value is below the monitoring limit value when a foreign body-free, but in particular gas-charged, medium passes.
if this is not the case, establishing that the foreign body is present in the medium.

1-17. (canceled)

18. A method for detecting a foreign body in a flowable medium, comprising the method steps of:
determining a first time curve of a first measured value using a first measuring device, for determining a physical density of the medium;
wherein the first measured value correlates with the physical density and/or the change in the physical density of the medium over time;
determining a second time curve of a second measured value using a second measuring device for ascertaining a relative permittivity of the medium;
wherein the second measured value correlates with the relative permittivity and/or a change in the relative permittivity of the medium over time,
determining a temporal correlation between the first curve and the second curve;
detecting pairs of measured values of the first measured value and the second measured value;
checking whether the detected pairs of measured values within a predefined tolerance interval correspond to the correlation of at least one predefined function; and
if this is not the case, establishing that the foreign body is present in the medium.

19. The method according to claim 18,
wherein at least one pair of measured values of the first measured value and the second measured value for a medium free of foreign bodies and bubbles, and/or pairs of measured values of the first measured value and the second measured value for a medium free of foreign bodies with an in particular variable gas charge can be represented by the at least one predefined function.

20. The method according to claim 18,
wherein pairs of measured values of the first measured value and the second measured value for a reference condition can be represented by the predefined function.

21. The method according to claim 20,
wherein the reference condition includes the passage of a plastics foreign body and/or a foreign body comprising silicon dioxide,
wherein the plastics foreign body of the first type has a density below a density limit value, in particular below 1000 kg/m³,
wherein the plastics foreign body of the second type has a density greater than the density limit value, in particular 1000 kg/m³.

22. The method according to claim 18,
wherein it is checked whether the detected pairs of measured values correspond to the context of a plurality of specified functions, within the respective predefined tolerance range.

23. The method according to claim 18,
wherein the checking comprises the generation of a monitoring value depending on the first measured value and the second measured value, and the comparison of the monitoring value with a monitoring criterion.

24. The method according to claim 23,
wherein a ratio of the first measured value, in particular the change in the physical density over time, and the second measured value, in particular the change in the relative permittivity over time, is included in the generation of the monitoring value.

25. The method according to claim 23,
wherein the first measured value is plotted against the second measured value, in particular the change in relative permittivity over time.

26. The method according to claim 23,
wherein the monitoring value has an angle between a measurement vector pointing to the pair of measured values and a reference axis,
wherein the monitoring criterion comprises an angular range.

27. The method according to claim 26,
wherein the measurement vector has a measurement vector length,
wherein the measurement vector length is included in the determination of the size of the foreign body.

28. The method according to claim 26,
wherein the measurement vector has a measurement vector length,
wherein a further monitoring criterion comprises a minimum length for the measurement vector length,
wherein this is only interpreted as being caused by a foreign body if the minimum length is exceeded.

29. The method according to claim 23,
wherein the monitoring value corresponds to a gradient of a reference straight line that runs through the pairs of measured values,
wherein the monitoring criterion defines a gradient range.

30. The method according to claim 18, comprising the method steps of:
creating a monitoring value depending on the measured value pairs,
wherein the first measured value is entered with a first weighting,
wherein the second measured value is entered with a second weighting;
comparing the monitoring value with a monitoring criterion,
wherein the monitoring criterion comprises an in particular variable monitoring limit value,
wherein the first weighting and the second weighting are selected such that the monitoring value is below the monitoring limit value when a foreign body-free, but in particular gas-charged, medium passes.

31. The method according to claim 18,
wherein the first curve and the second curve are correlated taking into account a measured flow value determined using the Coriolis flowmeter in combination with a distance between the Coriolis flowmeter and the second measuring device.

32. The method according to claim 18,
wherein the first curve and the second curve are correlated taking into account a time offset determined on the basis of a cross-correlation of the first curve and the second curve.

33. The method according to claim 18,
wherein the monitoring criterion is a variable criterion that is determined using a self-learning AI algorithm based on neural networks.

34. A measurement arrangement, comprising:
a pipeline for conveying a medium in a flow direction;
a first measuring device for determining a physical density of the medium,
a second measuring device for determining a relative permittivity of the medium,
wherein the first measuring device and the second measuring device are integrated in the pipeline and arranged offset to one another in the flow direction;
an evaluation circuit which is designed to carry out the following method:
determining a first time curve of a first measured value using the first measuring device, for determining a physical density of the medium;
wherein the first measured value correlates with the physical density and/or the change in the physical density of the medium over time;
determining a second time curve of a second measured value using the second measuring device for ascertaining a relative permittivity of the medium;
wherein the second measured value correlates with the relative permittivity and/or a change in the relative permittivity of the medium over time,
determining a temporal correlation between the first curve and the second curve;
detecting pairs of measured values of the first measured value and the second measured value;
checking whether the detected pairs of measured values within a predefined tolerance interval correspond to the correlation of at least one predefined function; and
if this is not the case, establishing that the foreign body is present in the medium.
